(19) United States
(12) Patent Application Publication
(10) Pub. No.: US 2014/0143187 A1
(43) Pub. Date: May 22, 2014

(54) METHOD FOR PROBABILISTICALLY PREDICTING LOCATION OF OBJECT

(71) Applicant: Ha Yoon Song, Mapo-gu (KR)

(72) Inventor: Ha Yoon Song, Mapo-gu (KR)

(21) Appl. No.: 14/082,553

(22) Filed: Nov. 18, 2013

(30) Foreign Application Priority Data
Nov. 19, 2012 (KR) 10-2012-0131104

(51) Int. Cl. G06N 3/08

(52) U.S. Cl. CPC G06N 3/08
USPC 706/12; 706/21

(57) ABSTRACT

Provided is a method for predicting location of an object by using a learning model which includes an input layer, a hidden layer, and an output layer each including one or more nodes, that are associated with each other by a weight. When a definitive time value is input to the input layer, the output layer is configured to output a probability value that the object is located at a specific place.

### CROSS-REFERENCE TO RELATED APPLICATION

This application claims priority to Korean Patent Application No. 10-2012-0131104 filed on Nov. 19, 2012 and all the benefits accruing therefrom under 35 U.S.C. §119, the contents of which are incorporated by reference in their entirety.

### BACKGROUND

The present invention relates to a method and apparatus of predicting location of an object, and more particularly, to a method of predicting location of a specific person according to time.

It is believed that personal mobility patterns of a human are highly related to a person's personality. One of the personality models, the big five personality models has been regarded as a representative model for personality identification.

The person's location at a given time can be identified in case the person carries positioning devices, and thus a personal mobility patterns, that is, a personal trail can be identified.

The very fundamental base theory of the present invention is from [1, 2] which identifies the latent patterns in human mobility and opens the predictability of human mobility trail: [1] Chaoming Song, Zehui Qu, Nicholas Blumm, Albert-Laszlo Barabasi, “Limits of predictability in human mobility”, Science, Vol. 327, pp. 1018-1021, 2010; and [2] Marta C. Gonzalez and A. Hidalgo and Albert-Laszlo Barabasi: Understanding individual human mobility patterns: Nature, (2008).

Since a person's action is related to many variables, it is not possible to completely predict personal mobility patterns. To predict personal actions, various data such as time, situation of property, and the like can be used. According to studies on relationships between time and human actions, it is known that the human actions every week have much influence on time. Therefore, a predication algorithm using a time variable is required.

### SUMMARY

The present invention provides a method of predicting location of a person when a specific time is input to a prediction model provided by certain embodiment of the present invention. The present invention also provides a method of predicting location of a person according to time, by additively inputting the person's personality parameter into the prediction model.

When a person carries a positioning device, the person's location can be identified at a given time, and thus the person's mobility patterns according to time can be identified.

And, a person's mobility pattern may be greatly related to the personality of him/her. The Big Five personality model has been considered as a representative model among various personality models. Research examples for the so-called BFF(Big-Five Factor) may be found in the following papers: [3] Schmitt D P, Allik J, McCrae R R, Benet-Martinez V. The geographic distribution of Big Five Personality Traits: patterns and profiles of human self-description across 56 nations. J. Cross Cult. Psychol. 2007, Vol. 38, pp. 73-212; and [4] Pervin L A, John O P. Handbook of Personality: Theory and Research. 2nd ed. New York, uilford, 1999.

In a domain of psychology, the Big Five factors of personality are five broad domains of human personality and they are used to describe human personality. At the early stage of personality research, 16 factors theory was firstly announced. Afterwards, Fiske [5] suggests that five factor model is more appropriate according to factor analysis: [5] Fiske, D. W., Consistency of the factorial structures of personality ratings from different sources. Journal of Abnormal and Social Psychology, Vol. 44, 1949, pp. 329-344.

Further, Tupes and Christal [6] reasserts the five factor model: [6] Tupes, E. L. and Christal, R. L., Recurrent personality factors based on trait ratings. Journal of Personality, 60, 1961, pp. 225-251.

Nowadays, the Big Five framework of personality traits emerged as a robust model for understanding the relationship between personality and various academic behaviors: [7] Poropat, A. E., “A meta-analysis of the five factor model of personality and academic performance”. Psychological Bulletin 135 (2), 2009, pp. 322-338.

The Big Five factors are:

Openness to experience (inventive/curious vs. consistent/cautious): Appreciation for art, emotion, adventure, unusual ideas, curiosity, and variety of experience. Openness reflects the degree of intellectual curiosity, creativity and a preference for novelty and variety. It is sometimes called ‘intellect’ rather than openness to experience.

Conscientiousness (efficient/organized vs. easygoing/careless): A tendency to show self-discipline, act dutifully, and aim for achievement, planned rather than spontaneous behavior, organized, and dependable.

Extraversion (outgoing/energetic vs. solitary/reserved): Energy, positive emotions, surgency, assertiveness, sociability and the tendency to seek stimulation in the company of others, and talkativeness.

Agreeableness (friendly/compassionate vs. cold/unkind): A tendency to be compassionate and cooperative rather than suspicious and antagonistic towards others.

Neuroticism (sensitive/nervous vs. secure/confident): The tendency to experience unpleasant emotions easily, such as anger, anxiety, depression, or vulnerability. Neuroticism also refers to the degree of emotional stability and impulse control, and is sometimes referred as emotional stability.

In order to identify a person's trail, the Big Five Inventory was developed by John et. al [8] which divides five factors into 44 questions: [8] John, O. P., Donahue, E. M., and Kentle. R. L., The Big Five inventory: versions 4a and 54. Institute of Personality Assessment and Research, Berkely, Calif. US, 1991. Each question has 1 to 5 points of weight for each factor. In one embodiment of the present invention, the BFI may be used for identifying a person's trail, and the BFI of the person may be considered as a major input for the model according to the present invention, wherein the model can provide a probabilistic location of the person at a given time.

Combining a personal mobility pattern and a personality, one aspect of the present invention presents a mechanism for finding the person's location at a given hour of a day.

A proper method maybe found to apply human personalities for human mobility model. Back Propagation Network (BPN) [9] may be adapted for one aspect of the present invention among the feasible techniques: [9] George F. Luger, Artificial Intelligence: Structures and Strategies for Complex Problem Solving (6th Edition), Pearson Education, Inc., ISBN-13: 978-032154589, March 2008. That is, in order to connect personality model and locations, BPN may be used as an underlying technology. As a result, the present invention finds a method to predict a person's location at a given time in combination of personality and personal mobility pattern.

Back Propagation Network (BPN) is one kind of neural network developed by Parker in 1982. It has output layer, hidden layer, and input layer. Each layer may be composed of arbitrary number of nodes. The nodes between each layer are connected and each connection edge has its own weight, so called connection strength.

According to an aspect of the present invention, a person's location can be predicted using a back-propagation network. At this time, a personality value by a personality model and a location value of the person may be associated with each other.

The method of predicting location of a person includes receiving time and/or the person's personality. That is, the time and/or the person's personality are regarded as main parameters for human mobility.

In an aspect of the present invention, a person's mobility model may be defined by using a Continuous Time Markov Chain (CTMC). This mobility model may be usefully used except that it does not reflect the person's personality parameter.

According to an aspect of the present invention, a method of predicting location of a specific object is performed by using a learning model including an input layer, a hidden layer, and an output layer each including nodes associated with each other by a link having a weight. In this regard, when a time value and a characteristic value of the specific object are input into the input layer, it is configured such that the output layer outputs a possibility value that the specific object is located at a specific place.

The term ‘node’ may be defined as an object of an abstract concept in which a node may have a specific value and the value may be changed by a special procedure and one of the nodes may be connected to another node by a link. The term ‘input layer’ indicates a set of one or more nodes having a specific value given by a user, and the term ‘output layer’ is a set of one or more nodes having result values according to a specific procedure set by a user. The term ‘hidden layer’ may mean a set of one or more nodes storing an intermediate result and an arbitrary value temporarily generated when a procedure set by a user is performed.

Respective one of the links may exist between the nodes of the ‘input layer’ and the node of the ‘hidden layer’ and between the nodes of the ‘hidden layer’ and the nodes of the ‘output layer’, and may have special weights given according to a procedure defined by a user.

According to the present invention, when time and/or personality of a specific person is input, the location of the specific person can be probabilistically predicted at a given time.

### BRIEF DESCRIPTION OF THE DRAWINGS

Exemplary embodiments can be understood in more detail from the following description taken in conjunction with the accompanying drawings, in which:

FIG. 1 shows an overall topology of a typical BPN;

FIG. 2 represents a learning model according to one embodiment of the present invention;

FIG. 3 shows a flow chart for training a learning model according to one embodiment of the present invention; and

FIG. 4 is a view for explaining an embodiment in which a probability value that specific object is located at a specific place is output by reflecting characteristic value of the specific object.

### DETAILED DESCRIPTION OF THE EMBODIMENTS

Hereinafter, specific embodiments will be described in detail with reference to the accompanying drawings.

Hereinafter, embodiments of the present invention will be described in detail with reference to the accompanying drawings. It will be understood that that the following embodiments are not provided to limit the present invention but are only provided to help the understanding of the present invention.

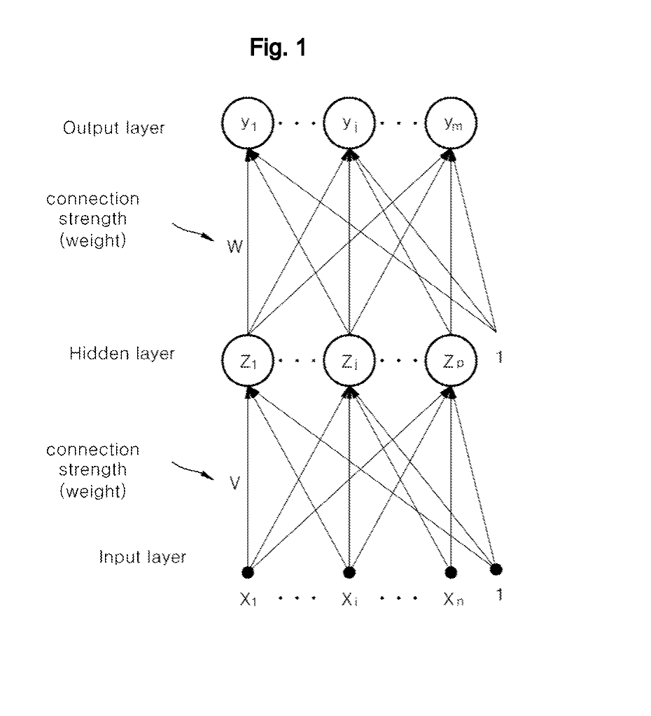

FIG. 1 shows an overall topology of a typical BPN.

When prepared input data for learning is applied to the input layer of the BPN, output data corresponding to the prepared input data for learning is output from the output layer. At this time, the output data may have a different value from prepared output data for learning. This is because the weights of the BPN may not have a value which is perfectly learned. The difference value between the prepared output data for learning and the output data from the output layer of the BPN is considered to be an error value of the output layer.

The error of output layer used to calibrate the connection strength between hidden layer and output layer, and the error of output layer is back propagated to hidden layer, then the connection weight between input layer and hidden layer will be calibrated. In sum, repetitions of three steps required: (1) inputting a leaning pattern and earning output, (2) earning error between output and desired values, and (3) back propagating error to calibrate connection strength.

The detailed process requires several parameters. Firstly, V and W must be defined and initialized as connection strength. Secondly, p patterns should be provided. Third, limitation of error, Eₘₐₓ must be determined. Then the output of hidden layer, Z can be derived as following Equation 1 and Equation 2:

$$\begin{matrix}{NET}_{z} = {XV}^{T} & [ Equation 1 ] \\ Z = f ( {NET}_{z} ) = \frac{1}{1 + {e}^{- {NET}_{z}}} & [ Equation 2 ]\end{matrix}$$

Also, output y can be derived as following Equation 3 and Equation 4:

$$\begin{matrix}{NET}_{y} = {ZW}^{T} & [ Equation 3 ] \\ y = f ( {NET}_{y} ) = \frac{1}{1 + {e}^{- {NET}_{y}}} & [ Equation 4 ]\end{matrix}$$

With the desired output d, error E can be calculated as following Equation 5.

$$E = \frac{1}{2} {( d - y )}^{2} \qquad [ Equation 5 ]$$

The error signal for hidden layer (δ_{z}) and output layer (δ_{y}) can be calculated as following Equation 6 and Equation 7:

$$\begin{matrix}{δ}_{y} = ( d - y ) y ( 1 - y ) & [ Equation 6 ] \\ {δ}_{z} = z ( 1 - z ) {\sum }_{i = 1}^{m} {δ}_{y} w & [ Equation 7 ]\end{matrix}$$

Then, ΔW which stands for difference of connection strength between hidden layer and output layer can be applied to connection strength for next step, Wₖ₊₁ as following Equation 8 and Equation 9.

ΔW=αδ_{y}Z [Equation 8]

Wₖ₊₁=Wₖ+ΔW [Equation 9]

Also ΔV and Vₖ₊₁ can be derived as following Equation 10 and Equation 11, for next learning step.

ΔV=αδ_{z}X [Equation 10]

Vₖ₊₁=Vₖ+ΔV [Equation 11]

Finally, E and Eₘₐₓ may be compared to each other in order to determine more repetitions or finish of the learning.

<Hourly Location Prediction: Experiment Design>

One of the purposes of the present invention is to provide hourly location prediction of a person using results of BFF models. The BFF model results may be adapted to BPN inputs. In one embodiment of the present invention, several inputs and outputs may be used for BPN. The inputs may represent time information as well as personality profile, combined with location information. The outputs may represent location information in a form of probabilities.

The output value of the BPN may be location information that is expressed in the form of a probability value. At this time, each output node of the BPN may correspond to a specific place, and a value of each output node may be a probability value that a person exists at the specific place.

In detail, the first input node may stand for AM/PM of a day, and the following second to fifth node data may represent time in a unit of hour and in binary number format. The sixth and seventh node data may represent days of a week. The weekly mobility pattern of a person may be supposed based on the research in the above mention document by Chaoming, etc. The output represents set of possible location of a person. The four output set could be home, school, restaurant, and church, or even it could be extended. Each member of output set has values in a form of probability, i.e. the outputs are always between 0 and 1.

For a process for learning output data, weight was given to each of location information corresponding to each output node. For example, in table 1, since the probability that a person is located at a mountain at 10 o'clock is low, −1 is given as a weight to represent that there is almost no probability that the person is located at the mountain, and when the probability that the person is located at a school at 10 o'clock is high, +1 is given as a weight to represent that the probability that the person is located at the house is high.

In order to setup an experiment with BPN, input node and output node values may be defined. Those exemplary values are represented in Table 1. The inputs may be a combination of hour in a day and possible locations. Possible locations may contain mountain, home, school and other miscellaneous places. It was drawn from person ‘A’s daily mobility pattern by himself.

TABLE 1

| Time(Hour) | Mountain | Etc. | House | School |
|---|---|---|---|---|
| 0 | −1 | −1 | 1 | 0 |
| 1 | −1 | −1 | 1 | 0 |
| 2 | −1 | −1 | 1 | 0 |
| 3 | −1 | −1 | 1 | 0 |
| 4 | −1 | −1 | 1 | 0 |
| 5 | −1 | −1 | 1 | 0 |
| 6 | −1 | −1 | 1 | 0 |
| 7 | −1 | −1 | 1 | 0 |
| 8 | −1 | −1 | 1 | 0 |
| 9 | −1 | −1 | 1 | 0.5 |
| 10 | −1 | −1 | 0.5 | 1 |
| 11 | −1 | −1 | 0.3 | 1 |
| 12 | −1 | −1 | 0 | 1 |
| 13 | −1 | −1 | 0 | 1 |
| 14 | −1 | −1 | 0 | 1 |
| 15 | −1 | −1 | 0 | 1 |
| 16 | −1\| | −1 | 0 | 1 |
| 17 | −1 | −1 | 0.3 | 1 |
| 18 | −1 | −1 | 0.5 | 1 |
| 19 | −0.3 | −1 | 0.5 | 0.5 |
| 20 | 0.3 | −1 | 1 | 0.3 |
| 21 | 1 | −1 | 0 | 0 |
| 22 | 0 | −1 | 0.5 | 0 |
| 23 | −1 | −1 | 1 | 0 |

As well, results of Big Five inventory for the person ‘A’ are presented in Table 2. The person ‘A’ has high openness and low extraversion in his personality.

TABLE 2

| | Agree- | Conscien- | | |
|---|---|---|---|---|
| Extraversion | ableness | tiouness | Neuroticism | Openness |
| 0.45 | 0.64 | 0.625 | 0.578 | 0.867 |

The output may be represented in a combination of hours and locations, each in a form of probability and thus need to be interpreted.

Two sorts of experiments have been conducted to see the effect of one embodiment of the present invention.

The first one is hourly location prediction without using BFF personality results. Eight input nodes and four output nodes, as well as ten hidden nodes were defined.

The respective output node corresponds to the respective location marked in the four right columns of table 1. For example, in table 1, output node 1 may correspond to mountain, output node 2 may correspond to etc., output node 3 may correspond to house, and output node 4 may correspond to school. The eight input nodes may consist of times of a day. For example, to represent 10 o'clock in table 1, ‘AM’ is input to the first node among eight input nodes, time ‘10:00:00 (h:m:s)’ may be input to second nodes to fifth nodes in the form of binary digit, and a value representing a day of week may be input to sixth to eighth nodes.

The second one is with BFF personality added on the experiment of the first one. The result of the second experiment is shown in Table 2. The resulting values shows probability values of big five factor of the person ‘A’. With the same number of hidden nodes and output nodes, thirteen input nodes were defined. Eight nodes represent hours and five nodes is adapted from the BFF result parameters of the person ‘A’.

In both cases, output shows each probability to be at corresponding location and hours.

<Experimental Results>

The First Experiment—Preliminary Experiment

The first experiment shows the effectiveness of BPN application for human location prediction. Eight input nodes, four output nodes and ten input nodes were defined as explained above. Connection strength values for each edge were randomly initialized with values in [−1, 1]. Instead of using Emax as a closing condition of BPN repetition, just 10,000 iterations were done for the first experiment.

After the learning process, the resulting weights were found. Table 3 shows the connection weight from input layer to hidden layer.

Each of ten columns in table 3 represents a hidden node, and each of eight rows represents an input node. Each of points where rows and columns cross each other represents a connection weight between the corresponding hidden node and input node.

TABLE 3

| | 1 | 2 | 3 | 4 | 5 | 6 | 7 | 8 | 9 | 10 |
|---|---|---|---|---|---|---|---|---|---|---|
| 1 | −2.07 | −4.85 | 2.19 | −0.17 | 0.62 | −4.08 | 1.94 | −1.65 | −6.01 | 0.39 |
| 2 | 12.06 | −2.33 | −10.21 | 4.22 | 1.34 | −3.91 | −5.77 | −9.68 | −10.9 | −0.52 |
| 3 | −13.16 | −2.27 | −6.34 | −6.45 | 4.04 | 0.44 | −2.66 | 3.82 | −0.36 | 6.14 |
| 4 | −4.06 | 0.08 | −4.12 | −0.15 | 0.79 | 2.23 | 6.68 | −2.83 | −0.47 | −5.64 |
| 5 | −4.12 | 0.68 | −3.95 | 0.85 | −0.22 | 6.26 | −0.73 | −3.1 | 3.85 | −11.2 |
| 6 | 2.57 | 1.64 | 2.34 | −0.11 | 0.13 | 6.19 | 1.91 | 4.7 | 0.19 | −7.2 |
| 7 | −6.27 | 2.71 | 3.47 | −4.31 | −6.17 | −4.73 | −7.18 | 0.41 | 10.7 | −5.83 |
| 8 | 0.98 | 1.28 | −2.49 | −0.22 | −0.46 | 0.09 | 1.21 | 0.75 | 9.17 | −0.61 |

Table 4 shows the connection weight from hidden layer to output layer.

TABLE 4

| | 1 | 2 | 3 | 4 |
|---|---|---|---|---|
| 1 | −2.80 | −3.41 | −20.2 | 3.52 |
| 2 | 9.44 | 8.44 | −1.28 | 6.66 |
| 3 | −2.68 | −1.59 | 21.83 | −7.98 |
| 4 | −20.51 | −17.21 | −0.55 | 16.48 |
| 5 | 14.76 | −24.12 | −0.46 | −6.50 |
| 6 | −16.17 | −13.98 | 1.99 | −10.30 |
| 7 | −15.66 | −9.34 | 19.12 | −3.79 |
| 8 | −18.71 | −17.71 | −25.65 | −7.51 |
| 9 | −19.33 | −17.92 | 7.40 | −20.31 |
| 10 | −13.73 | 4.61 | 20.61 | 4.08 |

After the learning process, the resulting output values are presented in Table 5. At 0 o'clock, the probability (0.98) that a person is located at house is the highest, at 9 o'clock, the probability (0.99) that the person is locate at school is the highest, and at 21 o'clock, the probability that the person is located at mountain is the highest, respectively. In another case, output values for two places may be similar to each other. In this case, it may be construed that the probability in one of the two places is similar to that in the other. Otherwise, it may be considered that a person is located between two places or is moving between two places. For example, in table 5, at 18 o'clock, it may be construed that the probability (0.46) in house is similar to that (0.44) in school or a person is on the way moving between house and school.

TABLE 5

| Time | Moutain | Etc. | House | School |
|---|---|---|---|---|
| 0 | 1.2E−22 | 2.8E−29 | 0.98 | 1.0E−10 |
| 1 | 1.2E−08 | 1.9E−21 | 0.98 | 5.6E−08 |
| 2 | 4.4E−10 | 5.9E−27 | 0.99 | 2.6E−06 |
| 3 | 2.7E−07 | 2.6E−17 | 0.99 | 1.5E−05 |
| 4 | 1.0E−17 | 6.4E−27 | 0.98 | 5.0E−05 |
| 5 | 1.3E−15 | 5.7E−24 | 0.98 | 0.002 |
| 6 | 1.3E−15 | 2.2E−24 | 0.97 | 0.01 |
| 7 | 4.4E−10 | 1.5E−17 | 0.97 | 4.2E−01 |
| 8 | 1.9E−16 | 5.5E−27 | 0.63 | 1 |
| 9 | 3.3E−05 | 3.0E−20 | 0.19 | 0.99 |
| 10 | 2.9E−14 | 7.3E−28 | 1.5E−05 | 0.99 |
| 11 | 5.1E−08 | 6.8E−18 | 1.5E−05 | 9.8E−01 |
| 12 | 7.6E−07 | 2.9E−20 | 1.0E−08 | 9.8E−01 |
| 13 | 1.8E−06 | 1.7E−19 | 1.1E−09 | 9.7E−01 |
| 14 | 1.4E−12 | 5.8E−25 | 1.6E−08 | 0.97 |
| 15 | 4.1E−11 | 3.1E−23 | 0.04 | 0.99 |
| 16 | 1.4E−15 | 3.8E−27 | 0.26 | 0.97 |
| 17 | 4.2E−15 | 1.6E−26 | 0.49 | 0.97 |
| 18 | 2.0E−18 | 2.0E−29 | 0.46 | 0.44 |
| 19 | 0.30 | 7.1E−10 | 1 | 0.28 |
| 20 | 0.98 | 1.6E−13 | 0.02 | 0.003 |
| 21 | 0.99 | 8.8E−14 | 0.49 | 0.002 |
| 22 | 0.008 | 1.9E−18 | 0.78 | 7.5E−07 |
| 23 | 3.7E−09 | 7.3E−22 | 0.98 | 4.3E−09 |

<The Second Experiment—Experiment with BFI Parameters>

After verifying one method according to the present invention with the above preliminary experiments, personality trail based experiment (the second experiment) was conducted. The 24 hours of day encoded to seven input nodes and five nodes were added for personality parameters. Input values are given to the remaining eight input nodes in the same manner as the above-described first experiment. Total 12 bits used for input nodes with the same configuration for other BPN parameters.

Table 6 shows the final result of one embodiment of the present invention. Since the resulting values in the table are all in probability values, interpretation of values is needed.

TABLE 6

| Time | Moutain | Etc. | House | School |
|---|---|---|---|---|
| 0 | 1.9E−12 | 2.0E−16 | 0.9998 | 0.0001 |
| 1 | 1.0E−12 | 2.9E−13 | 0.9999 | 0.0018 |
| 2 | 8.5E−12 | 2.4E−12 | 0.9965 | 0.0027 |
| 3 | 8.3E−15 | 1.9E−15 | 1 | 0.0022 |
| 4 | 2.8E−13 | 4.5E−16 | 0.9999 | 0.0019 |
| 5 | 4.8E−14 | 1.5E−13 | 0.9999 | 0.0026 |
| 6 | 3.1E−12 | 2.4E−12 | 0.9991 | 0.0034 |
| 7 | 7.5E−11 | 1.2E−11 | 0.9999 | 0.4968 |
| 8 | 1.8E−10 | 8.2E−13 | 0.5082 | 0.9952 |
| 9 | 3.5E−09 | 3.9E−11 | 0.2942 | 0.9915 |
| 10 | 1.6E−09 | 4.0E−10 | 0.0100 | 0.9992 |
| 11 | 1.7E−07 | 8.0E−12 | 0.0033 | 0.9998 |
| 12 | 3.4E−08 | 7.4E−13 | 4.9E−05 | 0.9991 |
| 13 | 1.1E−08 | 4.8E−10 | 0.0033 | 0.9994 |
| 14 | 3.9E−09 | 4.7E−11 | 0.0015 | 0.9939 |
| 15 | 2.3E−10 | 1.8E−11 | 0.0052 | 0.9999 |
| 16 | 4.5E−11 | 5.6E−13 | 0.2873 | 0.9936 |
| 17 | 4.1E−11 | 8.5E−10 | 0.4999 | 0.9995 |
| 18 | 1.7E−10 | 1.1E−11 | 0.5282 | 0.4881 |
| 19 | 0.2994 | 1.1E−05 | 0.9928 | 0.2985 |
| 20 | 0.9936 | 3.8E−08 | 0.0087 | 0.0047 |
| 21 | 0.9896 | 7.0E−06 | 0.4965 | 0.0018 |
| 22 | 0.0103 | 1.0E−06 | 0.8008 | 0.0089 |
| 23 | 0.0690 | 5.0E−05 | 0.9706 | 0.0095 |

Table 7 shows the interpretation of the final results of Table 6. For example, at 09:00 PM, the person ‘A’ is highly probably in the mountain however probability has gone home.

TABLE 7

| Hour | Interpretation | Extra Interpretation |
|---|---|---|
| 00:00 | Almostly at home | |
| 1:00 | Almostly at home | |
| 2:00 | Almostly at home | |
| 3:00 | Almostly at home | |
| 4:00 | Almostly at home | |
| 5:00 | Almostly at home | |
| 6:00 | Almostly at home | |
| 7:00 | Almostly at home | Probably has moved to school |
| 8:00 | Almostly at school | Probably has moved to school |
| 9:00 | Almostly at school | |
| 10:00 | Almostly at school | |
| 11:00 | Almostly at school | |
| 12:00 | Almostly at school | |
| 13:00 | Almostly at school | |
| 14:00 | Almostly at school | |
| 15:00 | Almostly at school | |
| 16:00 | Almostly at school | |
| 17:00 | Almostly at school | Probably has gone home |
| 18:00 | Probably at home | Probably has gone home |
| 19:00 | Almostly at home | |
| 20:00 | Almostly in the mountain | |
| 21:00 | Almostly in the mountain | Probably has gone home |
| 22:00 | Probably at home | |
| 23:00 | Almostly at home | |

To predict the hourly location of a person, the above explained experiment was conducted based on three sort of prerequisite knowledge. The first one was an assumption of routinely pattern of human locations. The second one is human personality trails so called Big Five factors. The third one is a methodology of probabilistic machine learning as BPN. The combination of different knowledge successfully leads to a prediction method of human location.

In order to improve the method according to the present invention, several extra considerations could be made. There are so many other parameters of human location including exceptional behavior of human. Therefore, the extra location could be defined as a parameter of BPN, and it can be supposed that a parameter of high extraversion could cause a high probability of extra location as a hourly location of a human.

Maybe a prepared human mobility model as shown in [10] could be used as more detailed parameters of BPN inputs: [10] Hyunuk Kim and Ha Yoon Song, Formulating Human Mobility Model in a Form of Continuous Time Markov Chain, The 3rd International Conference on Ambient Systems, Networks and Technologies, Aug. 27-29, 2012, Niagara Falls, Ontario, Canada. In case the combination works, more precise prediction of hourly location could be made.

The BFI is not a unique one of human personality trail. There could be many other application of human personality models like [11, 12]: [11] Jillian Anable, ‘Complacement Car Addicts’ or ‘Aspring Enviromentalists’? Identifying travel behaviour segments using attitude theory”, Transport Policy, Vol. 12, pp. 65-78, 2005; and [12] Bas Verplanken, Henk Aarts, Ad Van Knippenberg, Habit, information acquisition, and the process of making travel mode choices, European Journal of Social Psychology, 27, pp. 539-560, 1997. And, if one of the other applications is applied, the quality of location prediction can be improved, and the personality models cab be verified as well.

### Embodiment: Learning Model According to an Embodiment of the Present Invention

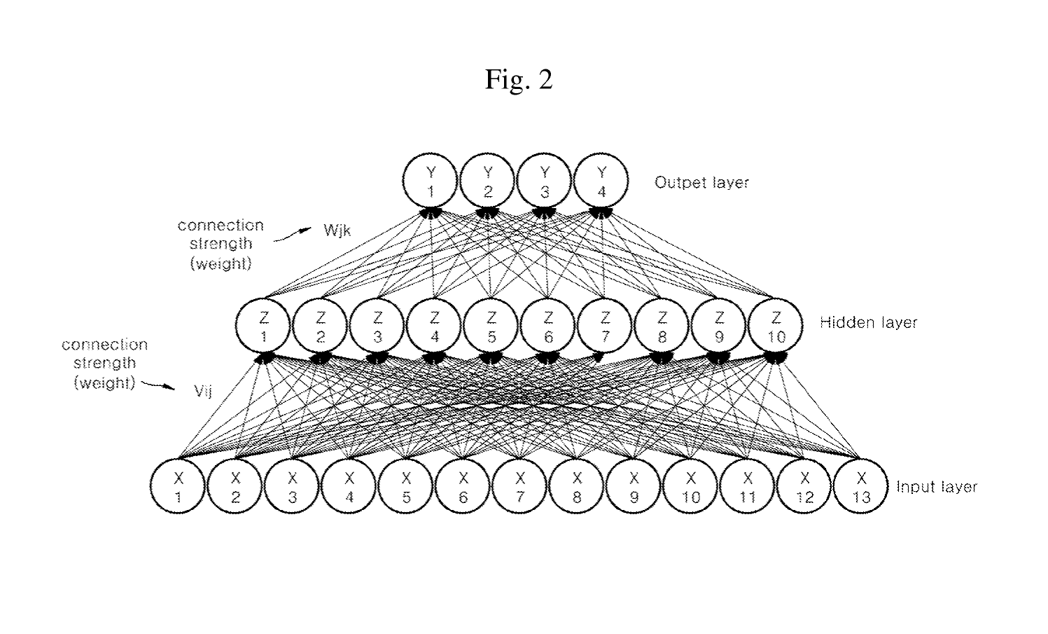

FIG. 2 is a schematic view illustrating a learning model according to an embodiment of the present invention. The learning model includes thirteen (13) input nodes, ten (10) hidden nodes, and four (4) output nodes. Weights (Vij, Wjk) between nodes may be set to a predetermined initial value. 24 hours a day and/or day of the week are encoded to 8 parameters and respectively input to input nodes X1 to X8, and five personality values according to BFI results may be respectively input to input nodes X9 to X13. At this time, the values inputted to the input nodes X9 to X13 reflect individual personalities, and, for a specific person, these values may be provided as constant values that are substantially not changed with time. However, as viewed from a long-term perspective, since the individual personalities may be changed, the values inputted to input nodes X9 to X13 may be changed also.

Since the values inputted to input nodes X1 to X8 are changed with time, when N (e.g., 100,000) samples of location and time are, for example, obtained from a positioning device of a specific person, N-number input data may be provided. Each input data value included in this input data set is a definitive time value.

N-number input data may be obtained, for example, during four weeks. The specific person is not necessarily located at the same place every 9 A.M. of four Mondays. That is, the person may be located at school at 9 A.M. from the first to the third. Mondays, but may be located at house at 9 A.M., fourth Monday. Therefore, the probability that a specific person is located at a specific place at a specific time can be calculated from the N-number samples. For example, the probability that the specific person is located at home at 9 A.M., Monday may be ¼, and the probability that the specific person is located at school at 9 A.M., Monday may be ¾.

In another example, the N-number input data set may be obtained during specific one week. At this time, the specific person is not necessarily located at the same place at 9 A.M. from Monday to Sunday of the specific week, total 7 days. That is, the specific person may be located at school at 9 A.M. from Monday to Friday, at home on Saturday, and at mountain on Sunday. Therefore, the probability that a specific person is located at a specific place at a specific time can be calculated from the N-number samples. For example, in the above case, the probability that the specific person is located at home at 9 A.M. may be 1/7, the probability at mountain may be 1/7, and the probability at school may be 5/7.

From the above two examples, a specific time may be calculated in the daily, weekly, or monthly unit. The number of input nodes may be changed according to a specific method. Also, it is known that the possibility that a specific person is located at a specific place every time may be calculated in advance from the N-number location and time data.

When specific input data belonging to the input data set is input to input nodes X1 to X13, output values may be obtained from four output nodes Y1 to Y4 based on the connection strengths (weights) presently set in BPN. For example, output nodes Y1 to Y4 may correspond to home, school, mountain, and Etc., respectively. These output values may be compared with the probabilities that a specific person is located at locations of output nodes Y1 to Y4 at the corresponding input times. The connection strengths presently set in BPN may be updated such that error values obtained from comparison are minimized. Next, another input data set is inputted with respect to the updated BPN to obtain output values, the obtained output values are again compared with the above-mentioned probability values to again obtain output errors. To reduce these output errors, the connection strengths (weights) presently set in BPN may be again updated. By repeating this process, a model may be learned which is suitable for the location mobility pattern of a specific person. When a new time value is input to the learned model, a probability that the specific person is located at the time at a specific place may be obtained.

### Embodiment 2: Model Learning Method According to an Embodiment of the Present Invention

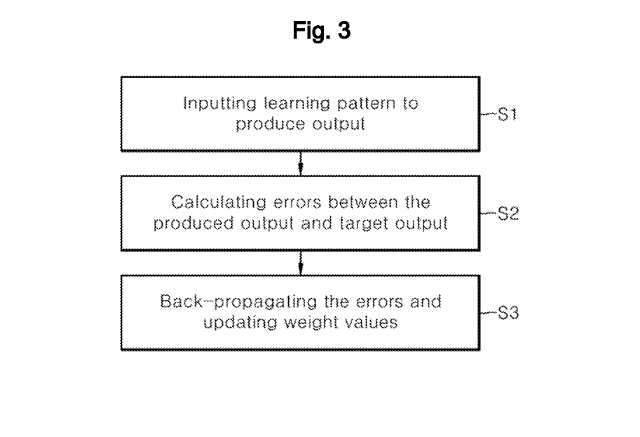

FIG. 3 is a schematic view showing a model learning method according to an embodiment of the present invention.

First, a learning model which includes an input layer, a hidden layer, and an output layer each including one or more nodes, that are associated with one another by weights, may be provided. In step S1, input data for learning including a definitive time value may be input to the input layer to obtain an output value from the output layer. In step S2, the obtained output value may be compared with a value calculated in advance to calculate an error value. In this regard, the value calculated in advance is related to a statistical value (i.e., probability value obtained in advance) that a specific person is located at the definitive time at a specific place. In step S3, the weights included in the learning model may be updated in order to minimize the error value. The minimizing tactic may be performed by using a mathematical algorithm well known in the art. By repeating these steps, the accuracy of the learning model can be enhanced.

### Embodiment 3: Method for Outputting Probability Value that Specific Object is Located at Specific Place by Reflecting Characteristic Value of Specific Object

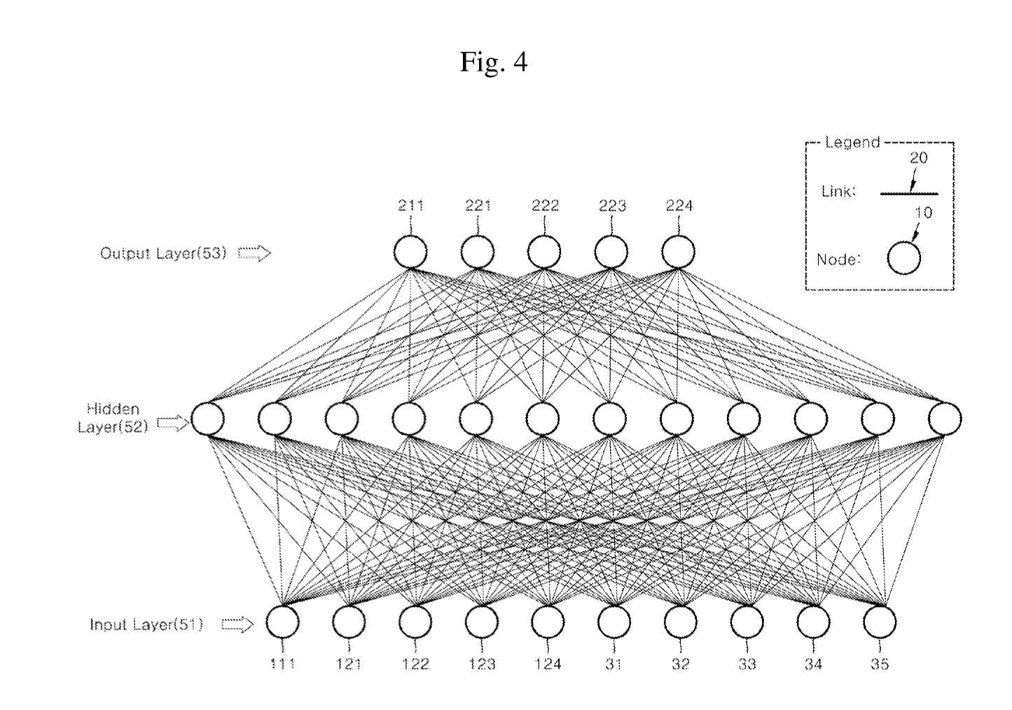

FIG. 4 is a view for explaining an embodiment in which a probability value that specific object is located at a specific place is output by reflecting characteristic value of the specific object. According to this embodiment, there may be provided a method of predicting location of a specific object by using a learning model including an input layer 51, a hidden layer 52, and an output layer 53 each including nodes 10 which are associated with each other by links 20 having weights.

A time value may be input to some of nodes of the input layer 51. For example, the some nodes may be one node 111 shown in FIG. 4. Unlike FIG. 4, the time value may be divided and input to two or more nodes included in the input layer 51 according to embodiments. The time value may be, for example, ‘2’ among ‘Time’ shown in Table 8.

Also, a scale representing an average possibility that a plurality of objects are located at a specific place at time (ex: Time=2) corresponding to the input time value may be input to other some nodes of the input layer 51. Here, the another some node may be, for example, any one of nodes 121 to 124 shown in FIG. 4. At this time, the specific place may be ‘House’ shown in Table 8, the plurality of objects may be a plurality of persons (ex.: 100 persons) selected arbitrarily, and the scale representing the average possibility that the plurality of persons (ex.: 100 persons) are located at the specific place (ex.: ‘House’) at the time (ex.: Time=2) may be ‘0.75’ shown in Table 8. In another example, the specific place may be ‘School’ shown in Table 8, the plurality of objects may be a plurality of persons (ex.: 100 persons) selected arbitrarily, and the scale representing the average possibility that the plurality of persons (ex.: 100 persons) are located at the specific place (ex.: ‘School’) at the time (ex.: Time=2) may be ‘0.25’ shown in Table 8. At this time, values regarding different places may be input to different nodes (ex.: 121 to 124). For example, scales values (ex.: 0.75, 0.25, 0, and 0) regarding “House’, ‘School’, ‘Mountain’, and ‘Etc.’ shown in Table 8 may be input to nodes 121, 122, 123, and 124, respectively. The above-mentioned ‘scale’ may be an average of real values obtained by really tracking locations of the plurality of persons (ex.: 100 persons).

TABLE 8

Original data

| Time | House | School | Mountain | Etc. |
|---|---|---|---|---|
| 0 | 1 | 0 | 0 | 0 |
| 1 | 1 | 0 | 0 | 0 |
| 2 | 0.75 | 0.25 | 0 | 0 |
| 3 | 0.5 | 0.5 | 0 | 0 |

Also, the characteristic value of the specific object may be input to another some node of the input layer 51. Here, the another some node may be, for example, any one of nodes 31 to 35 shown in FIG. 4. The specific object may be, for example, a specific person ‘A’. The characteristic value may be a value regarding personality of the person ‘A’. Such a characteristic value may be the above-described BFF value. For example, values, 0.45, 0.64, 0.625, 0.578, and 0.867 shown in Table 2 and corresponding to Extraversion, Agreeableness, Conscientiousness, Neuroticism, and Openness among BFF values of person ‘A’ may be input to nodes, 31, 32, 33, 34, and 35.

Next, when (1) time value, (2) scale, and (3) characteristic value are input to the input layer 51, the network is configured such that the output layer 53 outputs the probability value that the specific object is located at the specific place at the time value. For example, values representing the possibility that the specific person ‘A’ is located at ‘House’, ‘School’, ‘Mountain’, and ‘Etc.’ among the places shown in Table 8 at the time value (ex.: Time=2) may be output to nodes 221, 222, 223, and 224 of the output layer 53.

To realize the above-described embodiment, a weight associated with each link of the network model shown in FIG. 4 may be determined by learning. For example, in order to output the possibility that the specific person ‘A’ is located at ‘House’, ‘School’, ‘Mountain’, and ‘Etc.’ at the specific time value (Time=2) at the output layer 53, the values 2, 0.75, 0, and 0 shown in the third row of Table 8 are input to nodes 111, 121, 122, 123, and 124 of the input layer 51, and the values 0.45, 0.64, 0.625, 0.578, and 0.867 shown in Table 2 are respectively input to nodes 31, 32, 33, 34, and 35, thus capable of learning the network model. The same values that are input to the nodes 111, 121, 122, 123, and 124 of the input layer 51 may be input to nodes 211, 221, 222, 223, and 224 of the output layer 53 as initial values for learning. As a result, when the learning process of the network model shown in FIG. 4 is completed, values that the specific person ‘A’ is located at the specific place at the specific time value are output to nodes 221, 222, 223, and 224 of the output layer 53. For example, Table 9 shows values (ex.: probability values) regarding the possibility that the specific person ‘A’ is located at the specific place, which are output from nodes 121, 122, 123, and 124. From Table 9, it is seen that the possibilities that the specific person ‘A’ is located at ‘House’, ‘School’, ‘Mountain’, and ‘Etc.’ at Time=2 are respectively 0.5333, 0.540584, 0.000263, and 3.40E-06. These values are different from average values 0.75, 0.25, 0, and 0 regarding the possibilities that the plurality of persons (ex.: 100 persons) are located at ‘House’, ‘School’, ‘Mountain’, and ‘Etc.’ at Time=2. This is because a value regarding the personality of specific person ‘A’ is input to nodes 31 to 35 of the input layer 51 of the learning model shown in FIG. 4 to perform the learning. That is, the probability values output from the output layer 53 may be values reflecting an influence by the characteristic values (ex.: BFF values) of the specific object (ex.: specific person ‘A’).

By using the embodiments described through FIG. 4, Table 8, and Table 9, it may be observed how the possibility that the specific person is located at a specific place at a specific time is different from average possibility acquired from a plurality of persons according to values regarding the personality of the specific person (ex.: person ‘A’). That is, it may be observed how the possibility that a specific person is located at a specific place at a specific time is changed by the personality of the specific person.

TABLE 9

Trained data

| Time | House | School | Mountain | Etc. |
|---|---|---|---|---|
| 0 | 0.977493 | 3.54E−09 | 0.035141 | 0.023443 |
| 1 | 0.995207 | 0.001889 | 0.00196 | 0.000109 |
| 2 | 0.781381 | 0.278627 | 0.00039 | 5.34E−06 |
| 3 | 0.5333 | 0.540584 | 0.000263 | 3.40E−06 |

At this time, the specific object may be a specific person or a user device possessed by the specific person. The characteristic value may include one or more among the parameter (ex.: BFF value) regarding the personality of the specific person and the probability that the specific person is located at a specific place at the time value. The scale may be one acquired by using information collected by a user device possessed by the specific person, or provided in advance. The learning model may be a neural network.

### EXAMPLE 4

### Location Prediction Computing Apparatus for Implementing the Method of Embodiment 3

A location predicting computing apparatus according to Embodiment 4 may include a data acquiring unit and a processing unit.

The processing unit may be configured to predict location of the specific person by using a learning model including an input layer, a hidden layer, and an output layer each including nodes associated with each other by links having weights. The processing unit may be configured such that when (1) time value, (2) scale representing an average possibility that a plurality of objects are located at a specific place at the time value, and (3) characteristic value of the specific person are input to the input layer, the output layer outputs a probability value that the specific person is located at the specific place.

The data acquiring unit may be configured to acquire the time value, the scale, and the characteristic value and provide them to the processing unit. The data acquiring unit may acquire the information from an external data collection device, collect individual data, and temporarily or semi-permanently store the data, or acquire necessary data from database of an external server and temporarily or semi-permanently store the data.

One feature of the present invention includes predicting location of an object according to time, using a learning model for prediction, inputting a definitive time to an input layer of the learning model, and mapping a probability value that the object is located at a specific place at an input time of the input layer, to the output layer of the learning model. Also, the one feature of the present invention includes that each node of the output layer corresponds to a specific place.

It should be understood that the exemplary embodiments described therein should be considered in a descriptive sense only and not for purposes of limitation. Thus, the true technical protection scope of the present invention is to be determined by the technical spirit of the accompanying claims.

Although the [title] has(have) been described with reference to the specific embodiments, it(they) is(are) not limited thereto. Therefore, it will be readily understood by those skilled in the art that various modifications and changes can be made thereto without departing from the spirit and scope of the present invention defined by the appended claims.

What is claimed is:

1. A method for predicting location of a specific object by using a learning model comprising an input layer, a hidden layer, and an output layer, each including one or more nodes associated with each other by a link having a weight, wherein, when time value, scale representing an average possibility that a plurality of objects are located at a specific place at the time value, and characteristic value of the specific person are input to the input layer, the output layer is configured to output a probability value that the specific object is located at the specific place.

2. The method of claim 1, wherein the probability value is a value obtained by reflecting an influence by the characteristic value.

3. The method of claim 1, wherein the specific object is a specific person or a user device possessed by the specific person, and the characteristic value comprises one or more among a parameter regarding personality of the specific person and a probability that the specific person is located at the specific place at the time value.

4. The method of claim 3, wherein the scale is one acquired by using information collected by the user device possessed by the specific person, or provided in advance.

5. The method of claim 1, wherein the learning model is a neural network.

6. A location predicting computing apparatus comprising a data acquiring unit and a processing unit,
wherein the processing unit is configured to predict location of the specific object by using a learning model including an input layer, a hidden layer, and an output layer each including one or more nodes associated with each other by a link having a weight,
the processing unit is configured such that when time value, scale representing an average possibility that a plurality of objects are located at a specific place at the time value, and characteristic value of the specific person is input to the input layer, the output layer outputs a probability value that the specific object is located at the specific place, and
the data acquiring unit is configured to acquire the time value, the scale, and the characteristic value and provide the acquired time value, scale, and characteristic value to the processing unit.

7. The location predicting computing apparatus of claim 6, wherein the specific object is a specific person or a user device possessed by the specific person, and the characteristic value comprises one or more among a parameter regarding personality of the specific person and a probability that the specific person is located at the specific place at the time value.
